(19) United States
(12) Patent Application Publication
(10) Pub. No.: US 2002/0032832 A1
(43) Pub. Date: Mar. 14, 2002

(54) System and method for performance optimization of electronic devices

(75) Inventors: John W. Dykes, Eden Prairie, MN (US); Scott Daniel Ruebush, Plymouth, MN (US); Tong Shi, Eden Prairie, MN (US)

Correspondence Address: SCHWEGMAN, LUNDBERG,, WOESSNER & KLUTH, P.A., P.O. Box 2938, Minneapolis, MN, 55402, US

(73) Assignee: Seagate Technology LLC

(21) Appl. No.: 09/852,897

(22) Filed: May 10, 2001

Related U.S. Application Data
(60) Provisional application No. 60/202,530, filed on May 10, 2000.

(51) Int. Cl. G06F 12/00

(52) U.S. Cl. 711/112; 700/28; 711/170

(57) ABSTRACT

Systems and methods are provided through which one or more optimal operating parameters of an electronic device are determined by measuring the objective function of a combinatorial optimization algorithm, such as simulated annealing. For example, the operating parameters are stored in registers in the electronic device. The combinatorial optimization algorithm generates a value of each of the operating parameters of the electronic device. The objective function is measured by operating the electronic device using the value of the operating parameter, and recording at least one operating characteristic of the electronic device. Another value of the operating parameter is generated using the recorded operating characteristic. The process is repeated until an output of the combinatorial optimization algorithm indicates that for each operating parameter, the optimal value is determined. The combinatorial optimization algorithm coupled with the measured objective function provides a mathematically rigorous method for determining optimal operating parameters.

### RELATED APPLICATION

This application claims the benefit of U.S. Provisional Application Serial Number 60/202,530 filed May 10, 2000 under 35 U.S.C. 119(e).

This application claims the benefit of U.S. Provisional Application Serial Number 60/202,883 filed May 10, 2000 under 35 U.S.C. 119(e).

### FIELD OF THE INVENTION

This invention relates generally to optimizing operating parameters of electronic devices, and more particularly to optimizing register settings of disc drives for optimal performance.

### BACKGROUND OF THE INVENTION

One key component of any computer system is a device to store data. Computer systems have many different places where data can be stored. One common device for storing massive amounts of computer data is a disc drive. The basic parts of a disc drive are a disc assembly having at least one disc that is rotated, an actuator that moves a transducer to various locations over the rotating disc, circuitry that is used to write and/or read data to and from the disc via the transducer, and a bus interface to connect the disc drive into a data-handling system, such as a host computer. High-speed busses can have several data channels. A data channel will typically “burst” data to the bus for a short period of time, and then release the bus for use by other channels. Information representative of data is stored on the surface of the storage disc. Disc drive systems read and write information stored on tracks on storage discs.

A microprocessor controls many of the operations of the disc drive, including passing the data back to the requesting computer and taking data from a requesting computer for storing to the disc. The microprocessor is coupled to a memory which includes a read-only memory (ROM) and a random access memory (RAM). Registers that store control information and/or operating parameters are applied to a spin-motor controller or driver in the form of control signals that are communicated thereto.

The registers are loaded at initialization. Register settings for the reserved zone of the drive are stored in two separate locations in a non-volatile memory reserve zone, or a non-volatile memory, such as ROM. Once the drive is powered, the reserved zone register settings are read from the primary location, provided the check sum and key are correct. If the check sum and key are incorrect a possibly different set of default settings for the reserved zone are read from the secondary location in non-volatile memory. Once the drive has settings that will allow it to properly read the reserved cylinder data correctly, the drive reads the cylinder data, and stores the values in RAM registers. The preamp and channel register settings are stored by head and by zone in the reserved zone cylinders.

Spin stand testers normally comprise the mechanical portion of a disc drive, including one or more discs mounted to a spindle with a motor, and a head and actuator assembly operable to move the heads between inner and outer portions of the discs. Control circuitry rotates the discs and moves the heads across the disc surface, allowing simulation of an actual disc drive in operation.

Register values are predetermined and optimized for each head and for each zone during design of a model of an electronic device, such as a disc drive, and during the manufacture of each production run of the electronic device. Register values are predetermined for each design change of the electronic device, such as the request of an engineering design change. Design changes occur when any component in the design of the electronic device is changed. A component is changed when a component having different operating specifications is specified for the electronic device.

In a conventional empirical form of determining optimal register settings, the registers are “sweeped” to determine the estimated optimal value. The value of each register is iterated through the full range of values, and performance measurements are recorded. The value for each register at optimal performance is determined, and that value is used for the setting of the corresponding register. However, during the testing of any particular register, the other registers are not iterated through their entire range of values because the number of combinations would be impractical to test. Instead, the values of the other registers are held constant for estimation of the optimal value of any particular register.

Sweeping the registers is problematic because the functional relationship between the components that the registers control is non-linear. The optimal performance of one component will vary depending upon the performance of other components. Where the register setting of one component is determined to be optimal, the optimal operating performance of another component will be at a register setting that is different than the register setting for the first register that was determined to be optimal in the sweeping analysis. The register settings that were determined to be optimal in the sweeping analysis will not necessarily be the optimal register settings, much less the global optimal register settings. The register setting may be globally optimized, but not because of having followed mathematically rigorous procedures. One or more registers can be swept at a time.

In a conventional empirical form of determining optimal register settings, this approach is problematic because determining the combinatorial optimization is a daunting task due to the massive number of combinations that must be analyzed. Typically, a disc drive includes dozens of registers that are optimized, wherein each register may represent as many as 256 values, the combination of which represents an unworkably large number of different combinations. The cost of determining the optimal register values is extremely expensive and time-consuming. In particular, the amount of time to perform this optimization cannot be easily accommodated under current short design and manufacturing cycles.

In analysis of performance of the electronic device, the optimization for the functions of the performance of the electronic device requires testing for each possible combination. The testing of each possible combination requires an impractical amount of computing resources and an impractical amount of time to perform the analysis.

The function of each register can be represented by an algebraic function. In non-linear situations, the algebraic functions can interact as functions of functions, or powers of one of the functions. In the non-linear situations, the performance of the electronic device can be analyzed by picking portions or grids of the function ranges, and estimating or attempting to determine local minima or maxima within each portion. However, these estimated local minima and maxima are rarely the precise, exact, actual global minima and maxima. Therefore, these estimates are, by definition, not globally optimized.

In addition, conventional systems determine operating parameters based on hypothetical estimates of performance of an electronic device, which may differ from empirical measurements. The difference between hypothetical estimates and empirical measurements introduces additional error into the optimization process.

What is needed is a system, method and/or apparatus that enables optimization of operating parameters using measured values as input to an objective function.

### SUMMARY OF THE INVENTION

The above-mentioned shortcomings, disadvantages and problems are addressed by the present invention, which will be understood by reading and studying the following specification.

In one embodiment, the present invention is characterized by systems and methods in which one or more optimal operating parameters of an electronic device are determined by measuring the objective function of a combinatorial optimization process or algorithm. In one example, the operating parameters are stored in registers in the electronic device. The combinatorial optimization algorithm generates a value of each of the operating parameters of the electronic device. The objective function is measured by operating the electronic device using the value of the operating parameter, and recording at least one operating characteristic of the electronic device. Another value of the operating parameter is generated using the recorded operating characteristic. The process is repeated until an output of the combinatorial optimization algorithm indicates that for each operating parameter, the optimal value of the electronic device is determined.

In one embodiment of the present invention, a computerized system for optimization of the operating parameters of a plurality of components of an electronic device includes a processor and a means operative on the processor for determining one or more optimal operating parameters from an empirical measurement of an objective function.

In another embodiment of the present invention, a method for optimizing overall performance of an electronic device includes determining one or more optimal operating parameters of the electronic device from an empirical measurement of an objective function, and thereafter communicating the operating parameters to a manufacturing process of the electronic device.

In another embodiment of the present invention, a computerized apparatus for optimizing performance of a plurality of components of the electronic device includes a determiner of one or more optimal operating parameters of the electronic device from an empirical measurement of an objective function. The apparatus also includes a communicator of the optimal operating parameters to a manufacturing process of the electronic device.

Advantageously, the systems and methods described provide optimization of operating parameters using measured values as input to an objective function. Using a combinatorial optimization algorithm coupled with a measured objective function provides a mathematically rigorous approach to determining optimal operating parameters.

In one embodiment, the present invention is characterized by providing a system, apparatus and method for determining optimal operating parameters of a mass storage device using a probabilistic combinatorial optimization process. The process implements a cost function. The cost function invokes empirical measurements of performance of a mass storage device. One example of a probabilistic combinatorial optimization process is simulated annealing. One embodiment that implements simulated annealing further implements a Metropolis function. A probabilistic process is used to introduce some extent of randomness into the optimization process, to enable a more thorough testing of various states, yet avoid an exhaustive and practically impossible testing of every possible combination.

In one aspect embodiment of the present invention, a computerized method for optimization of performance of a mass storage device includes initializing a best-accepted cost-function and a last-accepted cost-function value and generating a state from a probabilistic combinatorial optimization algorithm. Thereafter, a performance of an input/output function of the mass storage device in reference to the state is measured. The measurement is associated with a cost-function of the mass storage device. The measurement yields a measured value. Later, a cost-function value is generated from a cost-function and the measured value. Therefore, a state is generated using an extent of randomness, and the state is tested for effectiveness. When the cost-function value is less than the last-accepted cost-function value, a last-accepted cost-function value is set to the cost-function value. When the cost-function value is also less than the best-accepted cost-function value, a best-accepted cost-function value is set to the cost-function value. However, when the cost-function value is not less than the last-accepted cost-function value, the last-accepted cost-function value is set to the cost-function value in accordance with a Metropolis function.

In another embodiment aspect of the present invention, a computerized apparatus for optimizing performance of a plurality of components of a mass storage device includes a generator of a state. The state generator implements a probabilistic combinatorial optimization component. A measurer of a performance of an input/output function of the mass storage device receives the generated state and yields a measured value. A cost-function value is generated by a cost-function of the mass storage device from the measured value. When the cost-function value is less than the last-accepted cost-function value, another component updates a last-accepted cost-function value with the cost-function value and when the cost-function value is also less than the best-accepted cost-function value, yet another component sets a best-accepted cost-function value to the cost-function value. When the cost-function value is not less than the last-accepted cost-function value, still another component sets the last-accepted cost-function value to the cost-function value in accordance with a Metropolis function.

The illustrative embodiments of the present invention are characterized by systems, clients, servers, methods, and computer-readable media of varying scope. In addition to the aspects and advantages of the present invention described in this summary, further aspects and advantages of the embodiments of the invention will become apparent by reference to the drawings and by reading the detailed description that follows.

### BRIEF DESCRIPTION OF THE DRAWINGS

FIG. 1 is a block diagram that provides a system level overview of the operation of embodiments of the present invention for quality assurance of electronic devices.

FIG. 2 is a flowchart of a method for optimizing performance of an electronic device.

FIG. 3 is a flowchart of a method for determining one or more optimal operating parameters of the electronic device from an empirical measurement of an objective function in optimizing performance of an electronic device.

FIG. 4 is a flowchart of a method for optimization of performance of a mass storage device, according to an embodiment of the invention.

FIG. 5 is a flowchart of a method for measuring a performance of an input/output function of a mass storage device in reference to a state during optimization of performance of a mass storage device, according to an embodiment of the invention.

FIG. 6 is a flowchart of a method for initializing the last-accepted value, according to an embodiment of the invention.

FIG. 7 is a flowchart of a method for setting the last-accepted cost-function value to the cost-function value in accordance with a Metropolis function, according to an embodiment of the invention.

FIG. 8 is a block diagram of a computerized apparatus for optimizing performance of a plurality of components of the electronic device according to an embodiment of the invention.

FIG. 9 is a block diagram of a computerized apparatus for determining optimal performance of a plurality of components of the electronic device according to an embodiment of the invention.

FIG. 10 is a block diagram of a computerized apparatus for performance optimization of electronic device according to an embodiment of the invention.

FIG. 11 is a block diagram of a computerized apparatus for optimizing performance of a plurality of components of a mass storage device, according to an embodiment of the invention.

FIG. 12 is an exploded view of a disc drive in accordance with an embodiment of the present invention.

FIG. 13 is a high-level block diagram showing the main data paths in a conventional high-level disc drive architecture.

FIG. 14 is a schematic view of a computer system.

### DETAILED DESCRIPTION OF THE INVENTION

In the following detailed description of the preferred embodiments, reference is made to the accompanying drawings that form a part hereof, and in which are shown by way of illustration specific embodiments of the invention. It is to be understood that other embodiments may be utilized and structural changes may be made without departing from the scope of the present invention.

The invention described in this application is useful for all types of disc drives, including hard-disc drives, optical drives (such as CDROMs), ZIP drives, floppy-disc drives, and any other type of drive.

The detailed description is divided into four sections. In the first section, a system level overview is presented. In the second section, methods for an embodiment of the invention are provided. In the third section, apparatus in accordance with one embodiment of the invention is described. Finally, in the fourth section, a conclusion is provided.

### System Level Overview

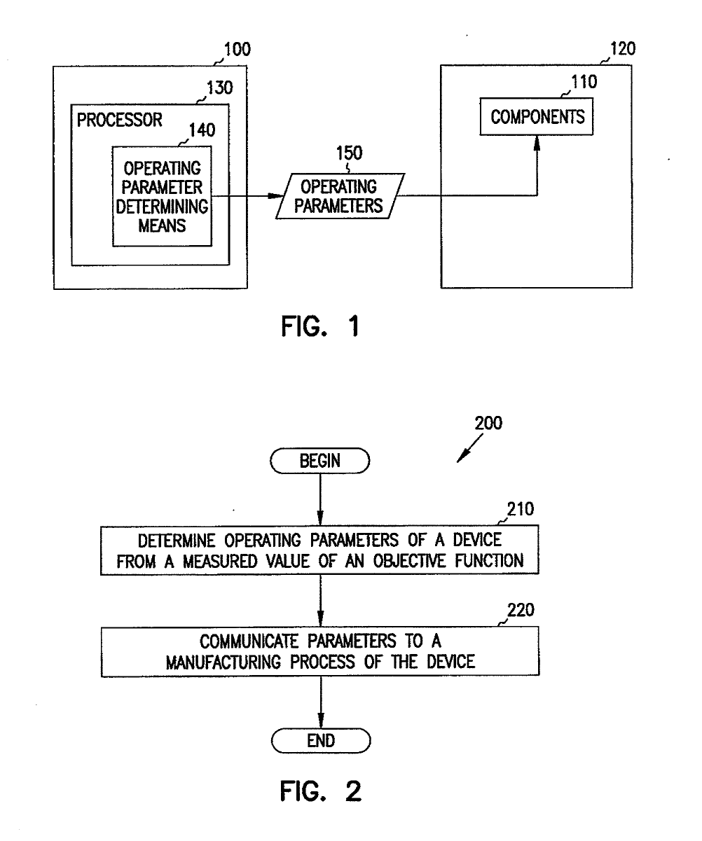

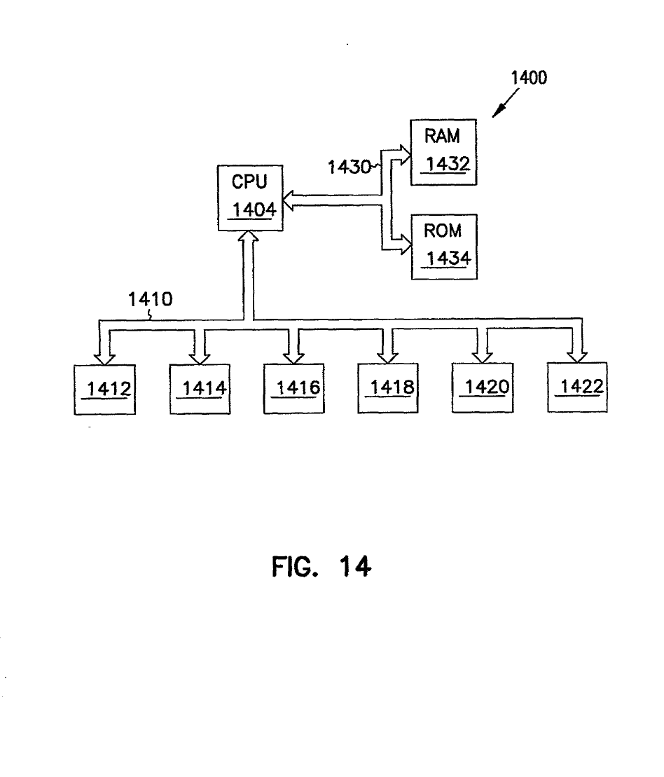

FIG. 1 is a block diagram that provides a system level overview 100 of the operation of embodiments of the present invention. Embodiments of the invention operate in a multi-processing, multi-threaded operating environment on a computer, such as computer 1400 in FIG. 14.

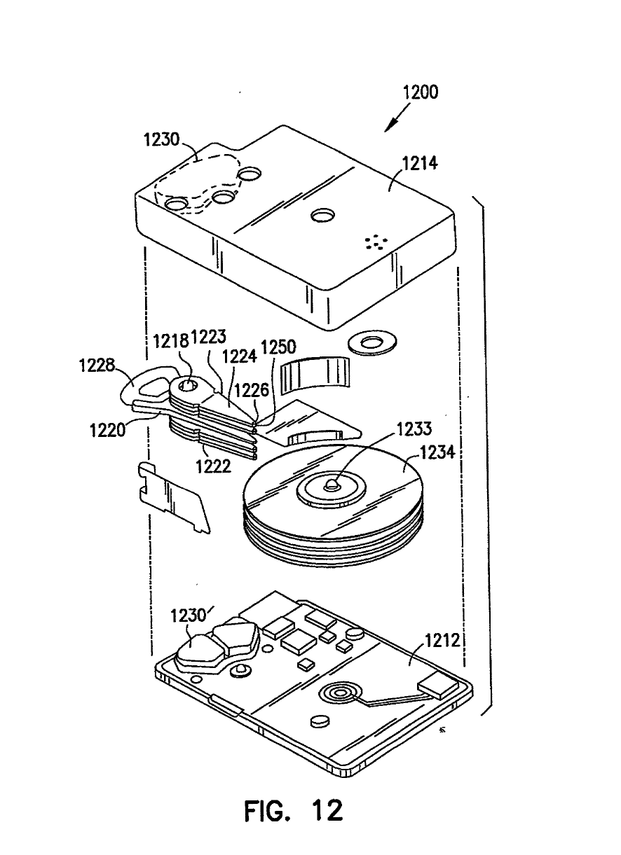

System 100 optimizes the performance of a plurality of components 110 of an electronic device 120. In one example, the electronic device 120 is a disc drive, such as disc drive 1200 in FIG. 12. System 100 includes a processor 130 and a means 140 operative on the processor 130 for determining one or more optimal operating parameters 150, of the one or more of the plurality of components 110 of the electronic device 120, from an empirical measurement of an objective function coupled with a combinatorial optimization algorithm. Examples of a combinatorial optimization algorithms are genetic algorithm and simulated annealing. In one embodiment of system 100, the optimal operating parameters 150 are global optimal operating parameters.

System 100 provides the advantage of optimization of the operating parameters 150 of the electronic device 120. Using a combinatorial optimization algorithm coupled with a measured objective function provides a mathematically rigorous method for determining optimal operating parameters.

### Description of the Preferred Embodiment

FIG. 2 is a flowchart of a method 200 for optimizing performance of an electronic device. Method 200 includes determining one or more optimal operating parameters of the electronic device from an empirical measurement of an objective function 210. The objective function represents a function of the electronic device. In one embodiment, the optimal operating parameters are global optimal operating parameters. In another embodiment, the empirical measurement is a measured value.

In one embodiment of step 210, the objective function is an objective function of a combinatorial optimization algorithm. The mathematical objective is to minimize an objective function. The mathematical combinatorial optimization resolves for the objective function. The objective function is related non-linearly to the input. The inputs are embodied as discrete integer values, such as a hexadecimal value that is conventional in register values. The function of each register is represented by an algebraic function. In non-linear situations, the algebraic functions can interact as functions of functions, or powers of one of the functions.

One example of a combinatorial optimization algorithm is a genetic algorithm (GA). A GA is a model of optimization, which derives its behavior from a metaphor of some of the mechanisms of evolution in nature. This is done by the generation of a population of individual states that are analogous to the chromosomes in DNA. The states in the population then go through a process of simulated “evolution”.

A GA is an iterative algorithm that generates each new output from an objective function definition, an implementation of a genetic representation, and an implementation of one of more genetic operators.

When the genetic algorithm is implemented it is usually done in a manner that involves the following cycle: Evaluate the fitness of all of the states in the population. Create a new population by performing operations such as crossover, fitness proportionate reproduction and mutation on the state whose fitness has just been measured. Discard the old population and iterate using the new population.

One iteration of this cycle is referred to as a generation. The first generation (generation 0) of this process operates on a population of randomly generated individuals. From there on, the genetic operations, in concert with the fitness measure, operate to improve the population. Thereafter, the one or more optimal operating parameters that are determined in step 210 are communicated to a manufacturing process of the electronic device 220. In varying embodiments, method 200 is performed during design of a model of an electronic device, or during the manufacture of a production run of the electronic device.

Method 200 enables optimization of operating parameters using measured values as input to an objective function.

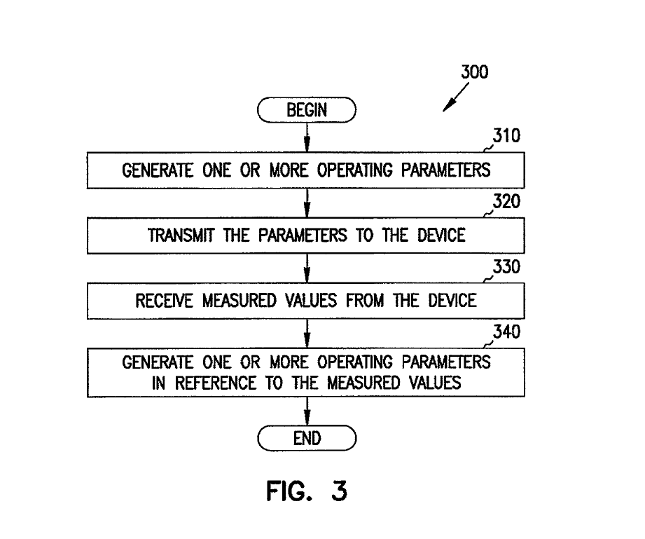

FIG. 3 is a flowchart of a method 300 for determining one or more optimal operating parameters of the electronic device from an empirical measurement of an objective function in optimizing performance of an electronic device, as in step 210 in FIG. 2. The determination is a recursive, heuristic method 300 that includes generating one or more operating parameters 310. The one or more generated operating parameters are transmitted to the electronic device 320. The device performs functions using the operating parameters, and the device transmits one or more measured values of the performance of the performed functions of the electronic device. The measured values are received 330. Thereafter, one or more second operating parameters are generated in reference to the one or more measured values 340. In one embodiment, a singular measured value is an average of a plurality of measured values. In another embodiment, the empirical measurement is a measured value. In one example, the operating parameters are a value of a register of the electronic device. In another example, the operating parameters are a system state of the electronic device. In yet another embodiment, the optimal operating parameters are global optimal operating parameters.

Method 300 enables optimization of operating parameters using measured values as input to an objective function. Using a combinatorial optimization algorithm coupled with a measured objective function provides a mathematically rigorous method for determining optimal operating parameters.

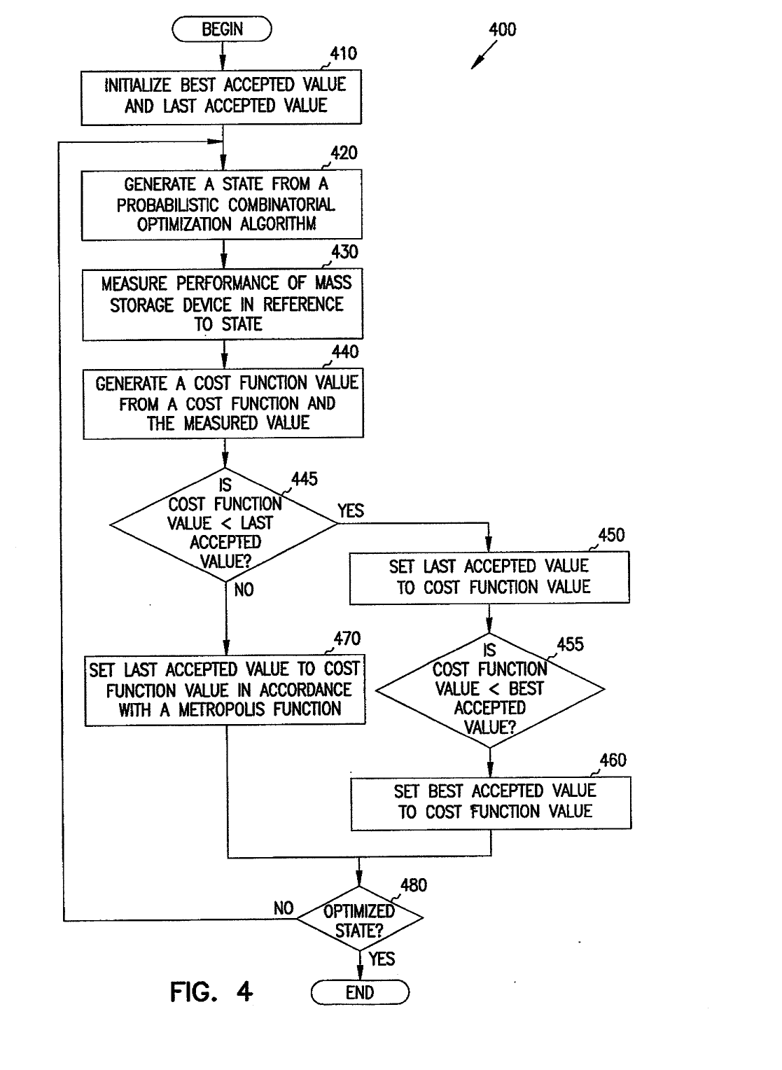

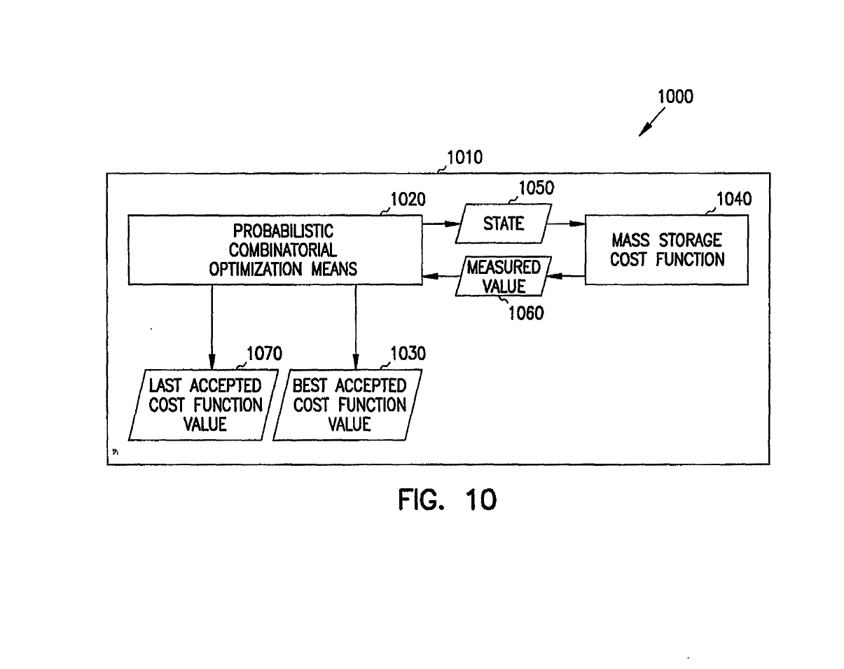

FIG. 4 is a flowchart of a method 400 for optimization of performance of a mass storage device, according to an embodiment of the invention. Method 400 includes initializing 410 a best-accepted cost-function value and initializing a last-accepted cost-function value. The best-accepted cost-function represents the value of the cost-function having the best value during the performance of the method. The best-accepted cost-function value is depicted as the best-accepted cost-function value 1030 in FIG. 10. In varying embodiments, the mass storage device is a disc drive such as disc drive 1200 in FIG. 12, and/or a disc drive spin-stand.

Method 400 also includes generating 420 a state from a probabilistic combinatorial optimization algorithm. A probabilistic algorithm involves backtracking where at each point there may be several possible actions and no way to chose between them except by trying each one and backtracking if it fails. In FIG. 10, the state is depicted as state 1050. The generating 420 is performed in FIG. 10 by the probabilistic combinatorial optimization means 1020.

Thereafter, method 400 includes measuring 430 a performance of an input/output function of the mass storage device in reference to the state. The measuring 430 is associated with a cost-function of the mass storage device. The measuring 430 yields one or more measured values. In FIG. 10, the cost-function of the mass storage device is depicted as the mass storage cost-function 1040. The measuring 430 is performed by the mass storage cost-function 1040 in FIG. 10. In varying embodiments, the measured value is an error rate measurement (metric) and/or a channel quality monitor measurement.

Subsequently, method 400 includes generating 440 a cost-function value from a cost-function and the measured value. In one embodiment, the cost function value is the measured value, in which the algorithm of the cost function merely passes the measured value as the cost-function value. In another embodiment, the cost function value is the average of a plurality of measured values, in which the algorithm of the cost function averages the plurality of measured values and passes the average as the cost-function value. The generating 440 is performed by the mass storage cost-function 1040 in FIG. 10.

The method also includes setting 450 a last-accepted cost-function value to the cost-function value, when the cost-function value is less than the last-accepted cost-function value 445. The last-accepted cost-function value is depicted in FIG. 10 as the last-accepted cost-function value 1070. The setting 450 is performed by the probabilistic combinatorial optimization means 1020 in FIG. 10.

The method further includes setting 460 a best-accepted cost-function value to the cost-function value when the cost-function value is less than the last-accepted cost-function value 445 and when the cost-function value is less than the best-accepted cost-function value 455. The best-accepted cost-function value is depicted in FIG. 10 as the best-accepted cost-function value 1030. The setting 460 is performed by the probabilistic combinatorial optimization means 1020 in FIG. 10.

Thereafter, method 400 includes when the cost-function value is not less than the last-accepted cost-function value, setting 470 the last-accepted cost-function value to the cost-function value in accordance with a simulated annealing function. The setting 470 is performed by the probabilistic combinatorial optimization means 1020 in FIG. 10. In another embodiment, a Barker/Boltzmann function is used rather than a Metropolis function.

Method 400 is performed 480 heuristically until an optimized state is generated. In one embodiment, the optimized state is represented by the best-accepted cost-function value, 1030 in FIG. 10.

Method 400 provides an effective optimization process for the optimization of operating parameters using measured values as input to an objective function. In one embodiment of method 400, the probabilistic combinatorial optimization algorithm is simulated annealing. Simulated annealing is a robust, general-purpose combinatorial optimization algorithm based on probabilistic methodology which has been applied successfully to many areas such as VLSI circuit design, neural-networks, image processing, code design, and capacitor placement in power systems.

Simulated annealing is a technique which can be applied to any minimization or learning process based on successive update steps, where the update step length is proportional to an arbitrarily set parameter, such as the state of method 400, which can play the role of a temperature. The name simulated annealing comes from an analogy between combinatorial optimization and the physical process of annealing.

Simulated annealing falls into a category of optimization algorithms known as probabilistic methods, since there is some randomness involved in determining the path taken in search of the solution. A sequence of solutions are generated by randomly creating a new solution via a perturbation to the current solution and then accepting or rejecting the new point with a certain probability which is dependent on the temperature and the change in the objective function.

Further embodiments of simulated annealing include cooperative simulated annealing, parallel simulated annealing, constrained simulated annealing, ensemble based simulated annealing, and adaptive simulated annealing. Alternatively, the probabilistic combinatorial optimization algorithm is genetic algorithm, 2-stage discrete optimization method, gradual neural network, branch-and-terminate, the dead-end elimination, intensive search procedure, non-diffident, or Greycon's deckle bench.

In another embodiment of method 400, the state is an operating parameter of the mass storage device. In a further embodiment, the operating parameter is a register value.

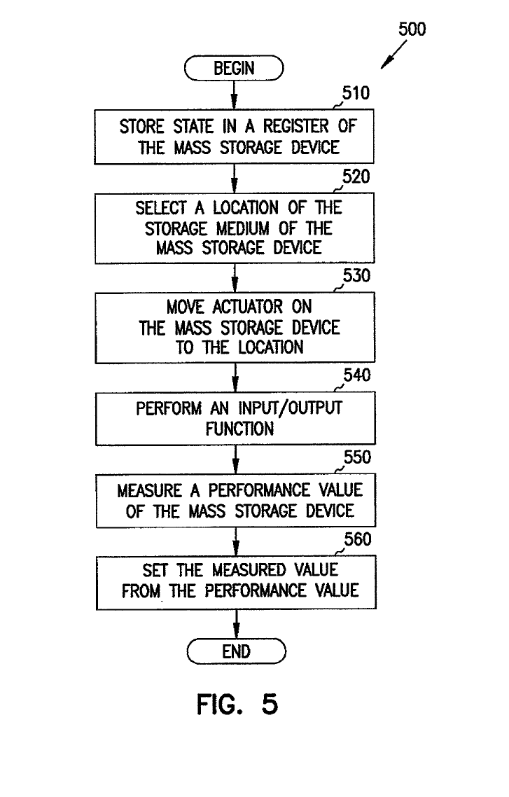

FIG. 5 is a flowchart of a method 500 for measuring a performance of an input/output function of a mass storage device in reference to a state during optimization of performance of a mass storage device, as in action 430 in FIG. 4, according to an embodiment of the invention. Method 500 provides an empirical measurement of the performance of the device.

Method 500 includes storing 510 the state in a register of the mass storage device. In one embodiment, before the state is stored 510 in a register, the state is generated by the probabilistic combinatorial optimization means 1020 in FIG. 10.

Method 500 also includes selecting 520 a location of the storage medium of the mass storage device.

Thereafter, method 500 subsequently includes moving 530 an actuator on the mass storage device to the location.

Method 500 further includes performing 540 an input/output function in reference to the location and the state. Step 540 invokes an empirical performance that can be measured.

Subsequently, method 500 also includes measuring 550 a performance value of the mass storage device. The performance value is an empirical measurement that solves the need in the prior art for empirical measured values as input to an objective.

Method 500 thereafter includes setting 560 the measured value from the performance value. Step 560 provides the empirical measured value as input to an objective function in the use of an effective optimization algorithm for the optimization of operating parameters.

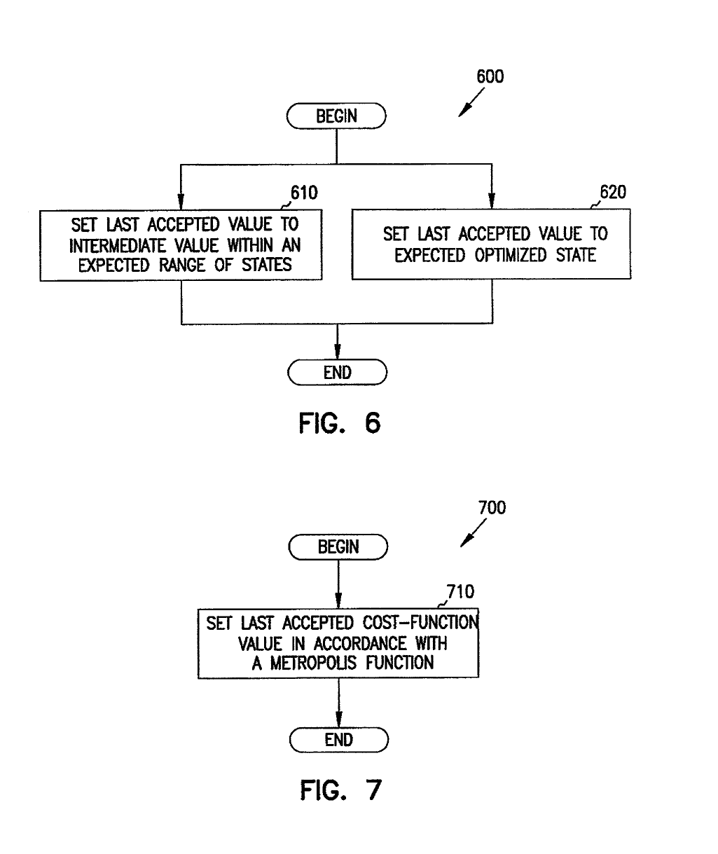

FIG. 6 is a flowchart of a method 600 for initializing the last-accepted value, as in action 410 in FIG. 4, according to an embodiment of the invention.

In one embodiment, the last-accepted cost-function value is initialized to a value that is an intermediate value within the expected range of states 610. In an alternative embodiment, the last-accepted cost-function value is initialized to a value that is the expected optimized state 620.

FIG. 7 is a flowchart of a method 700 for setting the last-accepted cost-function value to the cost-function value in accordance with a Metropolis function, as in action 470 in FIG. 4, according to an embodiment of the invention.

Method 700 includes setting 710 a last-accepted cost-function value from an exponent of the cost-function value subtracted from a last-accepted cost-function value denominated by temperature that is probably greater than a random number.

### Apparatus

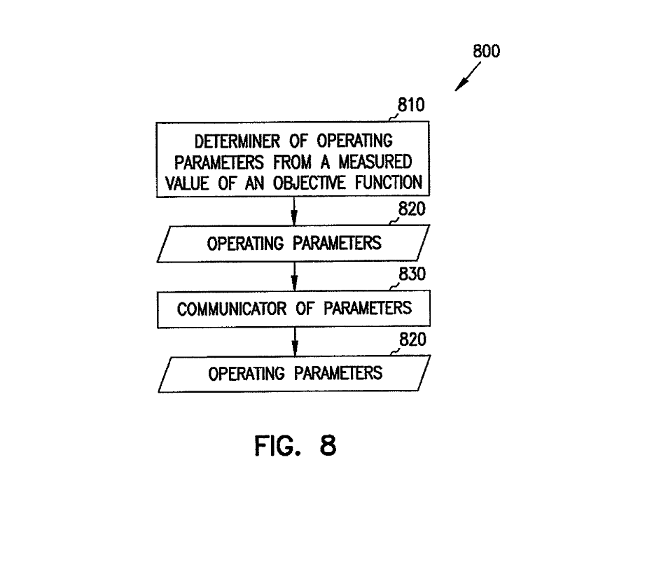

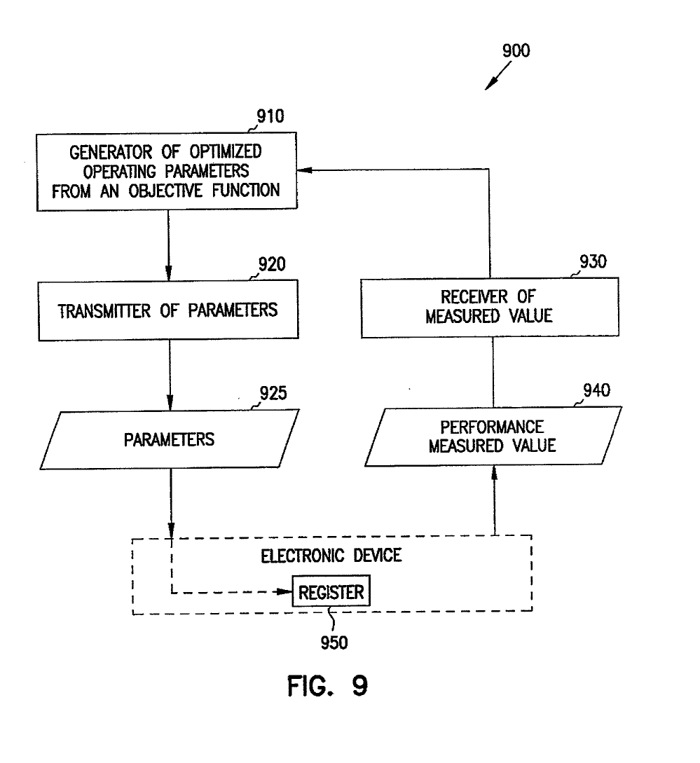

FIG. 8 is a block diagram of a computerized apparatus 800 for optimizing performance of a plurality of components of the electronic device according to an embodiment of the invention. Apparatus 800 includes a determiner 810 of one or more optimal operating parameters 820 of the electronic device from an empirical measurement of an objective function. In one embodiment, the empirical measurement is a measured value.

Apparatus 800 also includes a communicator 830 of the one or more optimal operating parameters 820 to a manufacturing process of the electronic device. The communicator 830 is operably coupled to the determiner 810.

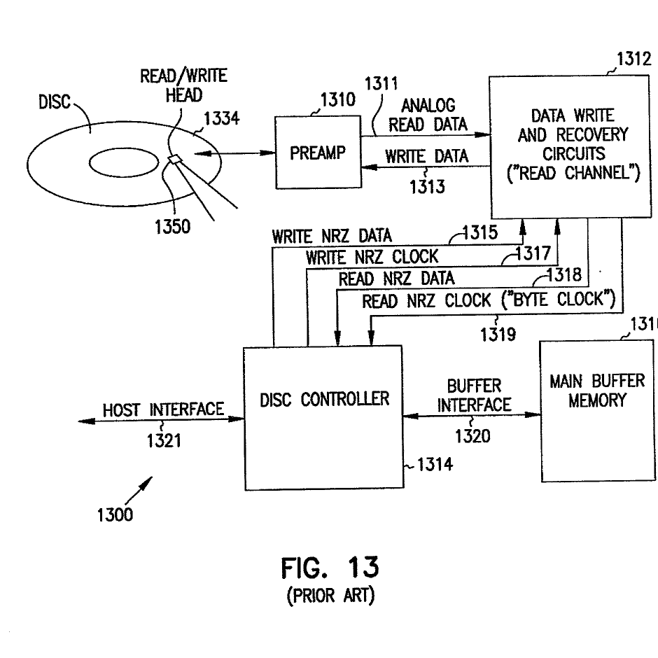

Determiner 810 is one example of the means 140 in FIG. 1 for determining one or more optimal operating parameters. Determiner 810 is also an example of apparatus that implements determining one or more optimal operating parameters of the electronic device from an empirical measurement of an objective function 210 in method 200 and method 300. In one embodiment, the optimal operating parameters are global optimal operating parameters. For example, the plurality of components of the mass storage device includes a pre-amplifier, such as pre-amplifier 1310 in FIG. 13 below, and/or a channel, such as read channel 1312 in FIG. 13 below, and a servo system.

Apparatus 800 enables optimization of operating parameters using measured values as input to an objective function.

FIG. 9 is a block diagram of a computerized apparatus 900 (or “determiner” 900) for determining optimal performance of a plurality of components of the electronic device according to an embodiment of the invention. The determiner 900 is one example of the determiner 810 in FIG. 8. Determiner 900 includes a generator 910 of the one or more optimized operating parameters. The generator 910 is operably coupled to a transmitter 920 of the one or more operating parameters 925 of the electronic device 960. The generator 910 is also operably coupled to a receiver 930 of an empirical measurement 940 of the performance of the electronic device 960. The performance occurs while the device 960 is using the one or more operating parameters 925. In one embodiment, the empirical measurement is a measured value. In another embodiment, the optimal operating parameters are global optimal operating parameters.

In another example, the one or more operating parameters are suitable for storage in a register of the microprocessor of the electronic device 960. One example of suitability of a parameter for storage in a register is having a format that is readily usable by the destination register, such as hexadecimal format. The measured value may be embodied as a measurement (metric) of a bit error rate (BER) of the electronic device 960, or as a measurement of the channel quality monitor (CQM). In one embodiment, the optimal operating parameters are global optimal operating parameters. Apparatus 900 enables optimization of operating parameters using measured values as input to an objective function.

Furthermore, in one example, the electronic device 960 is a mass storage device. In a further example, the mass storage device is a disc drive, such as disc drive 1200 in FIG. 12. In another example of an electronic device, the device is a disc drive spinstand.

FIG. 10 is a block diagram of a computerized apparatus for performance optimization of electronic device according to an embodiment of the invention. Embodiments of the invention operate in a multi-processing, multi-threaded operating environment on a computer, such as computer 1400 in FIG. 14.

Apparatus 1000 includes a processor 1010. Apparatus 1000 also includes a means 1020 operative on the processor 1010 for determining at least one optimal operating parameter, such as the best-accepted cost-function value 1030. The optimal operating parameter pertains to at least one of the plurality of components of the mass storage device. The function of the components is described by the mass storage cost-function 1040. The cost-function 1040 is an objective function. The probabilistic combinatorial optimization means 1020 sends a state 1050 to the mass storage cost-function 1040. The state 1050 is one of many possible states. The mass storage cost-function 1040 uses the state 1050 to generate a measured value 1060. The probabilistic combinatorial optimization means 1020 uses the measured value 1060 to update a last-accepted cost-function value 1070. The probabilistic combinatorial optimization means 1020 uses the measured value 1060 and the last-accepted cost-function value 1070 to update the best-accepted cost-function value 1030. A plurality of states 1050 are used to generate a plurality of associated measured values 1060, that are used to update the last-accepted cost-function value 1070 to update the best-accepted cost-function value 1030 until an optimized state is achieved.

Embodiments of the invention operate in a multi-processing, multi-threaded operating environment on a computer, such as computer 1400 in FIG. 14.

Apparatus 1000 provides an effective optimization process for the optimization of operating parameters using measured values as input to an objective function.

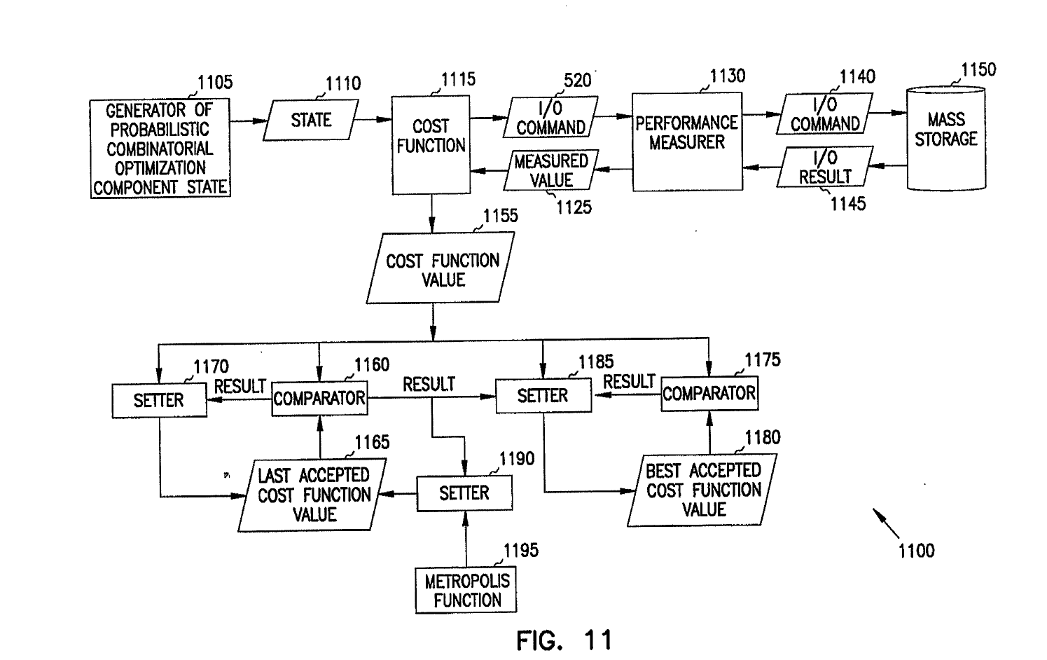

Referring to FIG. 11, apparatus of the invention is described in conjunction with the apparatus in FIG. 10 and the method in FIG. 4.

FIG. 11 is a block diagram of a computerized apparatus 1100 for optimizing performance of a plurality of components of a mass storage device 1150.

Apparatus 1100 includes a first generator 1105 of a state 1110 from a probabilistic combinatorial optimization component. Apparatus 1100 also includes a measurer 1130 of a performance of an input/output function of the plurality of components of the mass storage device 1150 in reference to the state 1110. One example of the performance is the I/O result 1145. The measurer yields a measured value 1125, operably coupled to the state generator 1105. In varying examples, the measured value 1125 is an error rate measurement (metric) and/or a channel quality monitor measurement.

In another example, the plurality of components of the mass storage device 1150 includes a pre-amplifier, such as pre-amplifier 1310 in FIG. 13 below, and/or a channel, such as read channel 1312 in FIG. 13 below, and a servo system.

Apparatus 1100 also includes a second generator 1115 of a cost-function value 1155 from a cost-function of the mass storage device 1150 and the measured value 1125. The second generator 1115 is operably coupled to the measurer 1130. Apparatus 1100 also includes a first comparator 1160 of the cost-function value 1155 to the last-accepted cost-function value 1165. The first comparator 1160 is operably coupled to the second generator 1115.

Apparatus 1100 also includes a first setter 1170 of a last-accepted cost-function value 1165 to the cost-function value 1165 when the cost-function value is less than 545 the last-accepted cost-function value 1165. The first setter is operably coupled to the first comparator 1160. Apparatus 1100 also includes a second comparator 1175 of the cost-function value 1155 to the best-accepted cost-function value 1180. The second comparator is operably coupled to the second generator 1115.

Apparatus 1100 also includes a second setter 1185 of a best-accepted cost-function value 1185 to the cost-function value 1155 when the cost-function value 1155 is less than 545 the last-accepted cost-function value 1165 and when the cost-function value 1165 is less than 555 the best-accepted cost-function value 1180. The second setter 1185 is operably coupled to the first comparator 1160 and the second comparator 1175. Apparatus 1100 also includes a third setter 1190 of the last-accepted cost-function value 1165 to the cost-function value 1155 in accordance with a Metropolis function 1195 when the cost-function value 1155 is not less than 570 the last-accepted cost-function value 1165. The third setter 1190 is operably coupled to the first comparator 1160.

Apparatus 1100 provides an effective optimization process for the optimization of operating parameters using measured values as input to an objective function.

The components of apparatus 1100 can be embodied as computer hardware circuitry or as a computer-readable program, or a combination of both. In varying embodiments, the mass storage device 1150 is a disc drive such as disc drive 1200 in FIG. 12, and/or a disc drive spin-stand.

The components of apparatus 800 and 900, 1000, and 1100 can be embodied as computer hardware circuitry or as a computer-readable program, or a combination of both.

More specifically, in the computer-readable program embodiment, the programs can be structured in an object-orientation using an object-oriented language such as Java, Smalltalk or C++, and the programs can be structured in a procedural-orientation using a procedural language such as C or assembly language. The software components communicate in any of a number of means that are well-known to those skilled in the art, such as application program interfaces (A.P.I.) or interprocess communication techniques such as remote procedure call (R.P.C.), common object request broker architecture (CORBA), Component Object Model (COM), Distributed Component Object Model (DCOM), Distributed System Object Model (DSOM) and Remote Method Invocation (RMI).

FIG. 12 is an exploded view of a disc drive in accordance with one embodiment of the present invention, this embodiment showing one type of disc drive 1200 having a rotary actuator. The disc drive 1200 is one example of mass storage devices, such as compact disc (CDROM) devices, tape cartridge devices, digital versatile disc (DVD) or digital video disc (DVD) devices. Other embodiments include other configurations and data recording and/or reading technologies. The disc drive 1200 includes a housing or base 1212, and a cover 1214. The base 1212 and cover 1214 form a disc enclosure. Rotatably attached to the base 1212 on an actuator shaft 1218 is an actuator assembly 1220. The actuator assembly 1220 includes a comb-like structure 1222 having a plurality of arms 1223. Attached to the separate arms 1223 on the comb 1222, are load beams or load springs 1224. Load beams or load springs are also referred to as suspensions. Attached at the end of each load spring 1224 is a slider 1226, which carries a magnetic transducer 1250. In some embodiments, transducer 1250 includes an electromagnetic coil write head and a magneto-resistive read head. The slider 1226 with the transducer 1250 form what is often called the head. It should be noted that many sliders have one transducer 1250 and that is what is shown in the figures. It should also be noted that this invention is equally applicable to sliders having more than one transducer, such as what is referred to as an MR or magneto resistive head in which one transducer 1250 is generally used for reading and another is generally used for writing. On the end of the actuator assembly 1220 opposite the load springs 1224 and the sliders 1226 is a voice coil 1228.

Attached within the base 1212 is a first magnet 1230 and a second magnet 1231. As shown in FIG. 12, the second magnet 1231 is associated with the cover 1214. The first and second magnets 1230, 1231, and the voice coil 1228 are the key components of a voice coil motor which applies a force to the actuator assembly 1220 to rotate it about the actuator shaft 1218. Also mounted to the base 1212 is a spindle motor. The spindle motor includes a rotating portion called a spindle hub 1233. In this particular disc drive, the spindle motor is within hub 1233. In FIG. 12, a number of discs 1234 (one or more; four are shown) are attached to the spindle hub 1233 to form disc assembly 1232. In other disc drives, a single disc or a different number of discs may be attached to the hub 1233. The invention described herein is equally applicable to disc drives which have a plurality of discs as well as disc drives that have a single disc. The invention described herein is also equally applicable to disc drives with spindle motors, which are within the hub 1233 or under the hub 1233.

FIG. 13 is a high-level block diagram showing the main data paths in a conventional high-level disc drive architecture 1300 for a typical disc drive system 1200. Only the main data paths between the host interface 1321 and the disc media 1234 are shown, and only the system's main components relevant to the invention are depicted.

One disc 1334 is shown, having transducer (read/write head) 1350 transferring data between the disc surface 1350 and pre-amplifier (preamp) 1310. Write data 1313 is transferred from circuit 1312 to preamp 1310 for write operations, based on write NRZ (non-return-to-zero) data 1315 and NRZ clock 1317. Analog read data is transferred from preamp 1310 to the recovery circuits of read channel 1312, which provides NRZ read data 1318 and NRZ read clock 1319 (also called the “byte clock”) to disc controller 1314. Data is transferred to and from main buffer memory 1316 of the disc drive across buffer interface 1320.

The read channel circuitry 1312 provides a byte clock 1319 to the disc controller 1314, matching the disc data rate both during read and write events and during idle periods when no data is being transferred to or from the media.

Disc controller 1314 is the heart of the disc drive from a data transfer management perspective. During disc reads, for example, it controls read channel 1312 to locate the appropriate physical position of the data on the media and to transfer the data into disc controller 1314, through data pipelines and FIFOs, and into main buffer memory 1316. Disc controller 1314 also typically includes logic to transfer the data from main buffer memory 1316, through data pipelines and FIFOs, and across host interface 1321. The subsystem within disc controller 1314 that is responsible for controlling the data traffic into and out of main buffer memory 1316 is referred to as the buffer controller.

Also, disc controller 1314 typically includes ECC encoder and decoder logic to protect the integrity of the data stored on the disc media and to correct relatively small errors in the data which result from imperfect disc media and from an imperfect read channel 1312. This error correction function within the disc controller 1314 typically requires functional support and bandwidth from the buffer controller to access main buffer memory 1316.

FIG. 14 is a schematic view of a computer system. Advantageously, the invention is well suited for use in a computer system 1400. The computer system 1400 may also be called an electronic system or an information handling system and includes a central processing unit 1404, a random access memory 1432, and a system bus 1430 for communicatively coupling the central processing unit 1404 and the random access memory 1432. The information handling system 1402 may also include an input/output bus 1410 and several peripheral devices, such as 1412, 1414, 1416, 1418, 1420, and 1422, which may be attached to the input output bus 1410. Peripheral devices may include hard disc drives, magneto optical drives, floppy disc drives, monitors, keyboards and other such peripherals.

### Conclusion

In conclusion, systems and methods are disclosed through which the global, overall, performance of a plurality of components 110 of an electronic device 120 is optimized, that includes a processor 130 and a means 140 operative on the processor 130 for determining one or more optimal operating parameters 150, of the one or more of a plurality of components 110 of the electronic device 120, from an empirical measurement of an objective function.

Method 200 for optimizing performance of an electronic device includes determining one or more optimal operating parameters of the electronic device from an empirical measurement of an objective function 210. The objective function represents a function of the electronic device. In one example, the objective function is an objective function of a combinatorial optimization algorithm. Thereafter, the one or more optimal operating parameters that are determined in step 210 are communicated to a manufacturing process of the electronic device 220.

In one example, the determining step 210 is a recursive, heuristic method 300 that includes generating one or more operating parameters 310. The one or more generated operating parameters are transmitted to the electronic device 320. The device performs functions using the operating parameters, and the device transmits one or more measured values of the performance of the performed functions of the electronic device. The measured values are received at 330. Thereafter, one or more second operating parameters are generated in reference to the measured value 340.

In one example, the operating parameters are a value of a register of the electronic device. In another example, the operating parameters are a system state of the electronic device.

Also disclosed is a method 400 for optimization of performance of a mass storage device, which includes initializing 410 a best-accepted cost-function value and initializing a last-accepted cost-function value. Method 400 also includes generating 420 a state from a probabilistic combinatorial optimization algorithm. Thereafter, method 400 includes measuring 430 a performance of an input/output function of the mass storage device in reference to the state. The measuring 430 is associated with a cost-function of the mass storage device. In one embodiment, the measuring 430 yields one or more measured values. In another embodiment, the measuring 430 yields an average of a plurality of measured values. Subsequently, method 400 includes generating 440 a cost-function value from a cost-function and the measured value. The method also includes setting 450 a last-accepted cost-function value to the cost-function value, when the cost-function value is less than the last-accepted cost-function value 445. Method 400 further includes setting 460 a best-accepted cost-function value to the cost-function value when the cost-function value is less than the last-accepted cost-function value 445 and when the cost-function value is less than the best-accepted cost-function value 455. Thereafter, method 400 includes, when the cost-function value is not less than the last-accepted cost-function value, setting 470 the last-accepted cost-function value to the cost-function value in accordance with a Metropolis function. In another embodiment, a Barker/Boltzmann function is used rather than a Metropolis function. Method 400 is performed 480 heuristically until an optimized state is generated.

A method 500 for measuring a performance of an input/output function of a mass storage device in reference to a state during optimization of performance of a mass storage device, as in action 430 in FIG. 4, is also disclosed. Method 500 includes storing 510 the state in a register of the mass storage device. Method 500 also includes selecting 520 a location of the storage medium of the mass storage device. Method 500 subsequently includes moving 530 an actuator on the mass storage device to the location. Method 500 further includes performing 540 an input/output function. Method 500 also includes measuring 550 a performance value of the mass storage device. Method 500 thereafter includes setting 560 the measured value from the performance value.

Method 600 for initializing the last-accepted value, as in action 410 in FIG. 4, is also disclosed. In one embodiment, the last-accepted cost-function value is initialized to a value that is an intermediate value within the expected range of states 610. In an alternative embodiment, the last-accepted cost-function value is initialized to a value that is the expected optimized state 620.

Method 700 discloses setting the last-accepted cost-function value to the cost-function value in accordance with a Metropolis function, as in action 470 in FIG. 4. Method 700 includes setting 710 a last-accepted cost-function value from an exponent of the cost-function value subtracted from a last-accepted cost-function value denominated by temperature that is probably greater than a random number.

Apparatus 800 for optimizing performance of a plurality of components of the electronic device includes a determiner 810 of one or more optimal operating parameters of the electronic device from an empirical measurement of an objective function. Apparatus 800 also includes a communicator 820 of the one or more optimal operating parameters to a manufacturing process of the electronic device. The communicator 820 is operably coupled to the determiner 810.

In one example of apparatus 800, the determiner 810 includes a generator 910 of the one or more operating parameters. The generator 910 is operably coupled to a transmitter 920 of the one or more operating parameters of the electronic device. The generator 910 is also operably coupled to a receiver 930 of an empirical measurement of the performance of the electronic device. The performance occurs while the device is using the one or more operating parameters.

In another example, the one or more operating parameters are suitable for storage in a register 950 of the microprocessor of the electronic device.

The measured value may be embodied as a measurement of error rate, or as a measurement of a channel quality monitor.

Apparatus 1000 also includes a means 1020 operative on the processor 1010 for determining at least one optimal operating parameter, such as the best-accepted cost-function value 1030. The function of the components is described by the mass storage cost-function 1040. The probabilistic combinatorial optimization means 1020 sends a state 1050 to the mass storage cost-function 1040. The mass storage cost-function 1040 uses the state 1050 to generate a measured value 1060. The probabilistic combinatorial optimization means 1020 uses the measured value 1060 to update a last-accepted cost-function value 1070. The probabilistic combinatorial optimization means 1020 uses the measured value 1060 and the last-accepted cost-function value 1070 to update the best-accepted cost-function value 1030.

Also disclosed is a computerized apparatus 1100 for optimizing performance of a plurality of components of a mass storage device 1150. Apparatus 1100 includes a first generator 1105 of a state 1110 from a probabilistic combinatorial optimization component. Apparatus 1100 also includes a measurer 1130 of a performance 1145 of an input/output function of the mass storage device 1150 in reference to the state 1110. The measurer yields a measured value 1125, operably coupled to the state generator 1105. Apparatus 1100 also includes a second generator 1115 of a cost-function value 1155 from a cost-function of the mass storage device 1150 and the measured value 1125, operably coupled to the measurer 1130. Apparatus 1100 also includes a first comparator 1160 of the cost-function value 1155 to the last-accepted cost-function value 1165, operably coupled to the second generator 1115. Apparatus 1100 also includes a first setter 1170 of a last-accepted cost-function value 1165 to the cost-function value 1165 when the cost-function value is less than 545 the last-accepted cost-function value 1165, operably coupled to the first comparator 1160. Apparatus 1100 also includes a second comparator 1175 of the cost-function value 1155 to the best-accepted cost-function value 1180, operably coupled to the second generator 1115. Apparatus 1100 also includes a second setter 1185 of a best-accepted cost-function value 1185 to the cost-function value 1155 when the cost-function value 1155 is less than 545 the last-accepted cost-function value 1165 and when the cost-function value 1165 is less than 555 the best-accepted cost-function value 1180, operably coupled to the first comparator 1160 and the second comparator 1175. Apparatus 1100 also includes a third setter 1190 of the last-accepted cost-function value 1165 to the cost-function value 1155 in accordance with a Metropolis function 1195 when the cost-function value 1155 is not less than 570 the last-accepted cost-function value 1165, operably coupled to the first comparator 1160.

Furthermore, in one example, the electronic device is a mass storage device. In a further example, the mass storage device is a disc drive. In another example of an electronic device, the device is a disc drive spinstand.

In another example, the plurality of components of the electronic device includes a pre-amplifier and/or a channel.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular application for the disc drive while maintaining substantially the same functionality without departing from the scope and spirit of the present invention. In addition, although the preferred embodiment described herein is directed to a system of determining an optimal operating parameter for a disc drive using simulated annealing from empirical measurements, it will be appreciated by those skilled in the art that the teachings of the present invention can be applied to other mass storage devices, like tape drives, and CD-ROM drive, and other combinatorial optimization algorithms without departing from the scope and spirit of the invention.

We claim:

1. A computerized method for optimizing performance of an electronic device, the method comprising steps of:
(a) determining at least one optimal operating parameter of the electronic device from an empirical measurement of an objective function of a probabilistic combinatorial optimization algorithm, wherein the objective function represents a function of the electronic device; and
(b) communicating the at least one optimal operating parameter to a manufacturing process of the electronic device.

2. The computerized method of claim 1, wherein the probabilistic combinatorial optimization algorithm further comprises simulated annealing.

3. The computerized method of claim 1, wherein the determining step (a) is performed heuristically until an optimized state is generated.

4. The computerized method of claim 1, wherein the determining step (a) further comprises:
(a)(1) measuring a performance of an input/output function of the mass storage device in reference to a probabilistic combinatorial optimization state, the measuring being associated with a cost-function of the mass storage device, yielding a measured value;
(a)(2) generating a cost-function value from a cost-function and the measured value;
(a)(3) setting a last-accepted cost-function value to the cost-function value when the cost-function value is less than the last-accepted cost-function value;
(a)(4) setting a best-accepted cost-function value to the cost-function value when the cost-function value is less than the last-accepted cost-function value and when the cost-function value is less than the best-accepted cost-function value; and
(a)(5) setting a last-accepted cost-function value to the cost-function value in accordance with a Metropolis function when the cost-function value is not less than the last-accepted cost-function value.

5. The computerized method of claim 1, wherein the empirical measurement further comprises an average of a plurality of measured values.

6. The computerized method of claim 1, wherein the operating parameter further comprises a register value.

7. The computerized method of claim 1, wherein the measured value further comprises an error rate measurement.

8. The computerized method of claim 1, wherein the empirical measurement further comprises a channel quality monitor measurement.

9. The computerized method of claim 1, wherein the electronic device further comprises a disc drive.

10. A computerized method for optimization of performance of a mass storage device, the method comprising steps of:
(a) generating a plurality of possible probabilistic combinatorial optimization states; and
(b) determining at least one optimal operating state of the mass storage device from the plurality of possible probabilistic combinatorial optimization states.

11. The computerized method of claim 10, wherein the determining step (b) further comprise:
(b)(1) measuring a performance of an input/output function of the mass storage device in reference to a probabilistic combinatorial optimization state, the measuring being associated with a cost-function of the mass storage device, yielding a measured value;
(b)(2) generating a cost-function value from a cost-function and the measured value;
(b)(3) setting a last-accepted cost-function value to the cost-function value when the cost-function value is less than the last-accepted cost-function value;
(b)(4) setting a best-accepted cost-function value to the cost-function value when the cost-function value is less than the last-accepted cost-function value and when the cost-function value is less than the best-accepted cost-function value; and
(b)(5) setting a last-accepted cost-function value to the cost-function value in accordance with a Metropolis function when the cost-function value is not less than the last-accepted cost-function value.

12. The computerized method of claim 10, wherein the measuring step (b)(1) further comprises:
(b)(1)(i) storing the state in a register of the mass storage device;
(b)(1)(ii) selecting a location of the medium of the mass storage device;
(b)(1)(iii) moving an actuator on the mass storage device to the location;
(b)(1)(iv) performing an input/output function;
(b)(1)(v) measuring a performance value of the mass storage device; and
(b)(1)(vi) setting the measured value from the performance value.

13. The computerized method of claim 10, wherein the setting step (b)(5) further comprises:
(b)(5)(i) setting a last-accepted cost-function value from an exponent of the cost-function value subtracted from a last-accepted cost-function value denominated by temperature that is probably greater than a random number, and when the cost-function value is not less than the last-accepted cost-function value.

14. The computerized method of claim 10, wherein the probabilistic combinatorial optimization further comprises simulated annealing.

15. A computerized apparatus for optimizing performance of a plurality of components of an electronic device, the apparatus comprising:
a determiner of at least one optimal operating parameter of the electronic device from a measured value of an objective function; and
a communicator of the at least one optimal operating parameter to a manufacturing process of the electronic device, the communicator operably coupled to the determiner.

16. The computerized apparatus of claim 15, wherein the determiner further comprises:
a generator of at least one operating parameter;
a transmitter of the at least one operating parameter to the electronic device, the transmitter operably coupled to the generator;
a receiver of a measured value of the performance of the electronic device using the at least one operating parameter, the receiver operably coupled to the generator.

17. The computerized apparatus of claim 15, wherein the determiner further comprises:
a first generator of a state from a probabilistic combinatorial optimization component;
a measurer of a performance of an input/output function of the mass storage device in reference to the state, yielding a measured value, the measurer being operably coupled to the state generator;
a second generator of a cost-function value from a cost-function of the mass storage device and the measured value, the second generator being operably coupled to the measurer;
a first comparator of the cost-function value to the last-accepted cost-function value, the first comparator being operably coupled to the second generator;
a first setter of a last-accepted cost-function value to the cost-function value when the cost-function value is less than the last-accepted cost-function value, the first setter being operably coupled to the first comparator;
a second comparator of the cost-function value to the best-accepted cost-function value, the second comparator being operably coupled to the second generator;
a second setter of a best-accepted cost-function value to the cost-function value when the cost-function value is less than the last-accepted cost-function value and when the cost-function value is less than the best-accepted cost-function value, the second setter being operably coupled to the first comparator and the second comparator; and
a third setter of the last-accepted cost-function value to the cost-function value in accordance with a Metropolis function when the cost-function value is not less than the last-accepted cost-function value, the third setter being operably coupled to the first comparator.

18. The computerized apparatus of claim 15, wherein the generator further comprises:
a generator of at least one operating parameter, the at least one operating parameter suitable for storage in a register.

19. The computerized apparatus of claim 15, wherein the measured value further comprises an error rate metric.

20. The computerized apparatus of claim 15, wherein the measured value further comprises a channel quality monitor.

21. The computerized apparatus of claim 15, wherein the electronic device further comprises a mass storage device.

22. The computerized apparatus of claim 21, wherein the mass storage device further comprises a disc drive.

23. The computerized apparatus of claim 21, wherein the mass storage device further comprises a disc drive spinstand.

24. The computerized apparatus of claim 15, wherein the plurality of components further comprises a pre-amplifier and a channel.

25. A system for optimizing performance of a plurality of components of an electronic device comprising:
a processor; and
a means operative on the processor for determining at least one optimal operating parameter, of at least one of the plurality of components of the electronic device, from a measured value of an objective function of a probabilistic combinatorial optimization algorithm.
